(19) United States
(12) Patent Application Publication
(10) Pub. No.: US 2014/0311977 A1
(43) Pub. Date: Oct. 23, 2014

(54) USE OF ORGANIC SOLVENT NANOFILTRATION AND LIQUID-LIQUID CHROMATOGRAPHY FOR THE RECOVERY OF PHARMACEUTICAL PRODUCTS

(71) Applicant: Glaxo Group Limited, Brentford, Middlesex (GB)

(72) Inventors: Christopher Pink, Stevenage (GB); Elin Rundquist, Stevenage (GB)

(73) Assignee: Glaxo Group Limited, Brentford, Middlesex (GB)

(21) Appl. No.: 14/358,787

(22) PCT Filed: Nov. 20, 2012
(86) PCT No.: PCT/EP2012/073027

§ 371 Date: May 16, 2014

(30) Foreign Application Priority Data
Nov. 22, 2011 (GB) 1120138.1

(51) Int. Cl. B01D 11/04

(52) U.S. Cl. CPC B01D 11/0415; B01D 2011/002
USPC 210/635; 210/638

(57) ABSTRACT

A process for separating a compound from solution in organic solvent by a chromatographic process, in particular liquid-liquid chromatography, in which prior to the chromatographic process the composition of the solution is changed by means of a process of organic solvent nanofiltration for a solvent exchange. Additionally or alternatively subsequent to the chromatographic process the output from the chromatographic process is subjected to a process of organic solvent nanofiltration to remove residual target compound and/or impurities in the output for solvent recovery.

This invention relates to a novel process, in particular to a process for the separation of a target compound from solution using chromatography, in particular liquid-liquid chromatography.

Chromatography is a well known separation method in which a liquid mobile phase containing a dissolved target substance is caused to flow over a stationary phase, and the dissolved target substance partitions between the mobile phase and the stationary phase so that the dissolved target substance becomes concentrated in fractions of the mobile phase and can be isolated from the mobile phase.

Typically in a chromatography process a flow of a stream of liquid mobile phase is established, then a sample of a solution of a target substance in a solvent medium which is miscible with the mobile phase is introduced into the stream to thereby flow in contact with the stationary phase.

Solid-liquid chromatography in which the stationary phase is solid is the most common type of chromatography. Typically particles of the solid are contained in a long tubular column.

Liquid-liquid chromatography is a known separation method. Liquid-liquid chromatography uses a two phase liquid system, comprising a stationary liquid phase and a mobile liquid phase. The stationary phase must form an immiscible phase with the liquid mobile phase to enable separation of components between the phases. However such a two phase system is inherently unstable and the stationary phase will always be partly soluble in the mobile phase resulting in a gradual stripping of stationary phase from the column. The stationary liquid phase can be supported on a solid material in a column (e.g. diatomaceous earth or silica gel), or by being maintained substantially in place by for example centrifugal forces in an elongate column (analogous to the solid phase contained in a tubular column in conventional solid-liquid chromatography) during operation, and a mobile liquid phase is caused to flow through the column in contact with the liquid stationary phase. During such flow, substances will partition between the mobile and stationary phases in a manner analogous to conventional solid-phase chromatography. In liquid-liquid chromatography techniques the mobile phase elutes the substances to be separated in fractions analogous to conventional liquid-solid phase chromatography.

Various liquid-liquid chromatography techniques are known.

One technique is liquid-liquid counter current chromatography (termed herein “CCC”). In a CCC apparatus a circular e.g. helical or spiral tubular column is rotated around plural axes in so-called planetary rotation. In the column is a liquid “stationary phase” held in place in the column by centrifugal force as the column rotates. A liquid “mobile phase” which forms an immiscible phase with the stationary phase, and containing a target compound dissolved therein is caused to flow through the column in contact with the stationary phase. Alternatively in some applications the target compound may be dissolved in the stationary phase. The combined rotational motion creates oscillating centrifugal force fields in the column which results in mixing and de-mixing zones of the stationary and mobile phases along the column, so that as the mobile phase flows along the column the target compound partitions between the mobile and stationary phases and becomes localized in a fraction of the mobile phase analogous to liquid-solid chromatography. A typical CCC apparatus is disclosed in WO-A-03/086639 (Brunel University).

Another known technique is centrifugal partition chromatography (termed herein “CPC”). Typically a CPC apparatus comprises a column comprising numerous (sometimes up to 1000) small chambers, sometimes called “partition cells”, which are arranged circumferentially in one or more circle for rotation around a rotation axis. These partition cells are further interconnected by flow channels so that a liquid may be caused to flow sequentially through them. In one known arrangement plural partition cells are etched or machined around a disk, e.g. made of a metal such as stainless steel, and plural discs are stacked along their central rotation axis to form a rotor which can be rotated around the rotation axis. Some forms of CPC apparatus having relatively few stacked discs and relatively larger volume partition cells are sometimes called centrifugal partition extractors. Typical CPC apparatuses are for example disclosed in U.S. Pat. No. 6,537,452 (Kromaton), WO-A-2004/079363 (Partus) and in other scientific and commercial literature.

In the CPC process a liquid phase is introduced into the series of partition cells and channels whilst the ring(s) of partition cells is rotated about the rotation axis. This rotation causes a centrifugal force which holds this phase, the stationary phase, in place. A second liquid phase, the mobile phase, may then be caused to flow through the partition cells, and a substance dissolved in the mobile phase can thereby be caused to partition between the mobile and stationary phases in a manner analogous to the way in which a substance partitions between a mobile eluant and a stationary solid phase in column chromatography.

A CPC apparatus may be operated in either a so called “descending” or “ascending” mode. If the mobile and stationary phases have different densities the centrifugal force generated by the rotation of the column causes the more dense phase to be radially more outward from the axis of rotation than the less dense phase. If the mobile phase is this more dense more radially outward phase this is called “descending mode”. Vice-versa if the stationary phase is this more dense more radially outward phase this is called “ascending mode”.

Chromatography, either solid-liquid or liquid-liquid, is frequently used for separating a target compound from a solution, such as a liquid reaction mixture, the so called “mother liquor”, or from waste products. However a common problem in such cases is that the solvent medium of the solution is not suitable for direct injection into a chromatographic column. To solve this problem, most commonly solvent is removed from the solution e.g. by heat or vacuum evaporation to provide a crude solid material which is dissolved in a suitable solvent medium to produce a sample suitable for chromatographic separation. Solvent medium for sample preparation is selected which is suitable for use as a mobile or stationary phase. Depending on respective boiling points full evaporation of all solvent can be difficult on a large scale. Concentration methods such as heat and vacuum evaporation require a substantial amount of energy, and can consequently be disadvantageous. High energy requirement can be a particular problem when the solution contains a relatively small proportion of the target compound. In the pharmaceutical industry the separation of compounds which are active pharmaceutical ingredients (“API”) from reaction mother liquors and liquid waste products is particularly important, as API can be extremely valuable.

It is an object of the present invention to address such problems of chromatographic sample preparation and separation of target compounds from impurities by providing a process which is both efficient in separation and is suitable for use on an industrial production scale. Other objectives and advantages of the present invention will be apparent from the following description.

According to the present invention a process is provided for separating a target compound from a solution of the target compound in an organic solvent medium by means of a chromatographic process using the solution as, or in mixture with, a liquid mobile or stationary phase together with a respective corresponding stationary phase or liquid mobile phase such that the target compound partitions between the liquid mobile phase and the stationary phase enabling the dissolved target compound to become concentrated in a fraction of the mobile phase, wherein:

prior to the chromatographic process the composition of a first solution of the target compound in a first organic solvent medium is changed by means of a process of organic solvent nanofiltration for a solvent exchange to provide said solution of the target compound as a second solution of the target compound in a second organic solvent medium having a different organic solvent composition from said first solution, and/or;

subsequent to said chromatographic process the mobile phase output from the chromatographic process is subjected to a process of organic solvent nanofiltration in which the output mobile phase from the chromatographic process is passed through an organic solvent nanofiltration membrane so that residual target compound and/or impurities in the output mobile phase are retained in the retentate and purified mobile phase passes through the membrane.

In one aspect of this invention the process of organic solvent nanofiltration for solvent exchange is performed prior to the chromatographic process to provide the solution.

According to this first aspect of the present invention a process for separating a target compound from a first solution of the target compound in a first organic solvent medium comprises the steps of:

changing the composition of the first solution using organic solvent nanofiltration for a solvent exchange to provide a second solution of the target compound in a second organic solvent medium,

then in a chromatographic process using the second solution as, or in mixture with, a liquid mobile or stationary phase together with a respective corresponding stationary phase or liquid mobile phase such that the target compound partitions between the liquid mobile phase and the stationary phase enabling the dissolved target compound to become concentrated in a fraction of the mobile phase.

Thereafter the target compound can be isolated from the fraction of the liquid mobile phase containing the target compound in solution, for example using known methods, for example crystallisation.

Organic solvent nanofiltration is a known membrane based separation process where an incoming feed stream of a solution of one or more solute in a solvent medium is passed through a membrane, usually using pressure as a driving force, and is thereby separated into two components referred to as the “permeate” (solvent and solute able to pass through the membrane) and the “retentate” (solvent and solute unable to pass through the membrane).

For a particular solution of a solute the selection of membrane and other process conditions depends on various factors, including among others the solvent(s) present in solution and the molecular size of the solute(s). The selectivity of organic solvent nanofiltration membranes is based primarily on steric factors, i.e. selecting a membrane which allows small, e.g. solvent, molecules to pass through while retaining larger solute molecules. In addition to such steric exclusion, membrane-solvent interactions, pressure, feed concentration, temperature and system charge can be used to fine tune the separation performance.

Membrane performance is most commonly described with regards to rejection and flux. Membrane rejection is defined as the percentage of a given solute that is unable to pass the membrane, and can be calculated according to Equation 1 where Rᵢ is the rejection of species i and Cᵢ is the concentration in the feed (f) and permeate (p) respectively:

$${R}_{i} = ( 1 - \frac{{C}_{i , p}}{{C}_{i , f}} ) \times 100 \qquad Equation 1$$

The rejection Rᵢ is sometimes defined as the ratio between the permeate and the retentate concentration, rather than the permeate and the feed. For the most accurate rejection measurement the concentration in the feed vessel at the time of permeate sampling should be used for calculations. However lab-scale batch filtration equipment does not usually allow feed sampling during the run, and an estimated concentration based on feed and retentate values is likely to be the most representative available value for the concentration. The permeate flux J is defined as the volume of solvent passing through a unit area of membrane per unit time. The flux is calculated according to Equation 2 where J is the flux, V is the volume, A is the membrane area and t is the collection time:

$$J = \frac{{V}_{p}}{At} \qquad Equation 2$$

An additional parameter often used to describe membrane separation performance is the molecular weight cut-off (MWCO), which is defined as the molecular weight for which 90% of a given solute is rejected by the membrane. MWCO values are often supplied by the manufacturer and provide an initial indication of the membrane operating range. However MWCO is highly dependent on the solvent-solute system used for membrane characterisation, and as varying methods are being employed by different manufacturers, caution must be applied before relying on these values. A further inadequacy relating to the application of MWCO is the change in molecular weight required to move the rejection from 90 to 100%. If the membrane rejection curve is not sharp, the molecular weight required to reach full rejection might be significantly higher than indicated by the MWCO. The shortcomings of current membrane characterisation techniques means that screening a large number of membranes remains an integral part of membrane process development.

Poorly defined MWCO curves have restricted the use of commercial organic solvent nanofiltration membranes in API recovery. Organic solvent nanofiltration can however be a useful tool for recovering clean solvent through use of a tight membrane that retains all species and for exchanging solvents.

The process of using organic solvent nanofiltration for a solvent exchange is also a known process, in which a first solution of one or more solute in a first organic solvent medium which might not be suitable for use as a liquid phase for a chromatographic process, is passed through a membrane as described above. Membrane passage allows some or preferably all of the solvent components of the first organic solvent medium to pass through as permeate while selectively retaining molecules of a solute in solution in the retentate. One or more solvent component of the second organic solvent medium are added to the retentate such that the solvent composition changes. Such a process may be repeated one or more time so that the composition of the solution is changed from the first solution to the second solution.

Such solvent component(s) of the second organic solvent medium may be added to the first solution at the same rate as liquid permeating through the membrane. If the rejection of the solute, e.g. target compound, is high the concentration of the solute in the retentate can remain at a constant level whilst the solvent composition changes from the first to the second organic solvent composition. Alternately if the solvent component(s) of the second organic solvent medium is added at a different rate than the rate of liquid permeating through the membrane the concentration of target compound in the second solution may be increased or decreased. Such a process may be performed as a continuous process.

Addition of such solvent component(s) and removal of permeate may be continued until the desired second solution composition is arrived at.

A suitable second solution composition is a composition which can be used as a liquid phase in the chromatographic process, e.g. as a mobile or stationary phase in liquid-liquid chromatography, or which is suitable for mixing with such a phase as a sample introduced thereinto.

Solvent exchange through nanofiltration can be carried out through a discontinuous or continuous process. In a discontinuous, also called a “put and take” process, the feed i.e. first solution is typically concentrated to a predetermined level by passage through the membrane before the passage is stopped, typically by depressurization, and the feed volume is adjusted by mixing with solvent component(s) of the second organic solvent medium, typically to the original volume. Such process steps may be repeated in cycles as necessary until the desired second solution composition is reached.

In a discontinuous or “put and take” process of solvent exchange using organic solvent nanofiltration each membrane passage of the solvent medium containing the target compound can be used to remove more than 50% of the solvent medium, e.g. up to 70% or more of the solvent medium (all % referred to herein in relation to liquid media are volume %). Until the desired organic solvent composition for the second solution is reached each membrane passage is followed by addition of solvent component(s) of the second organic solvent medium, typically to the original volume of the first solvent. In practice typically 5-8 such passages and additions has been found suitable to achieve a useable second solution.

In a continuous process, fresh solvent component(s) of the second organic solvent medium may be added to the first solution at a rate equivalent to the permeation such that the composition gradually changes from that of the first solution to that of the second solution. Continuous operation has the potential advantage of reduced need for process monitoring and manual operation, but the solvent requirement for a continuous process may be higher than for a discontinuous process.

Solvent exchange using organic solvent nanofiltration has the advantages of being a non-thermal process and is consequently advantageous for target compounds which are susceptible to thermal degradation. A further advantage of solvent exchange using organic solvent nanofiltration is that a solvent exchange is possible between any miscible solvents, including the otherwise difficult case of switching from a high to a low boiling point solvent.

Equipment for organic solvent nanofiltration is commercially available and can be used following manufacturer's specifications in a process of solvent exchange. An example of commercially available equipment for organic solvent nanofiltration is a MET™Cell Dead-end filtration system using a Starmen™ (trademark of UOP LLC, Des Plaines Ill., USA) 122 or 240 membrane.

To retain the maximum amount of solute(s) e.g. target compound in the retentate and hence minimize loss of target compound the membrane rejection Rᵢ for the target compound should be as high as possible. Preferably membrane rejection Rᵢ should be 90% or more, more preferably 95% or more, and in practice for many known target compounds which are active pharmaceutical compounds Rᵢ of 98.5% or more are achievable.

In addition to membrane rejection Rᵢ a high flux J, i.e. the rate of permeation per unit area of membrane, is desirable to minimize processing time for the solvent exchange using organic solvent nanofiltration. Flux is however related to membrane area and for a low flux a larger area can be used to maintain reasonable processing times. Suitable flux rates for a particular membrane and a particular solvent medium can be determined by experimentation.

The rejection of a particular solvent may vary for the same membrane when used with different organic solvent compositions. Consequently it may be advantageous to add solvent component(s) of the second organic solvent medium to the first solution of the target compound prior to subjecting the first solution to the process of solvent exchange. For example for the membrane used in the present Example (Starmen™ 122) the rejection of the target compound was found to be higher in the ethyl acetate-containing second solution compared to an initial solvent medium comprising methanol, methyl isobutyl ketone and toluene. By addition of ethyl acetate to the first solution the rejection of the target compound increased during processing and the overall losses of the target compound reduced.

For example 40% or more, e.g. 50% or more of a second organic solvent such as ethyl acetate may be added to the first solution prior to passing it through the membrane.

In an embodiment the first solution of the target compound may be a mother liquor collected from a crystallization of the target compound. Mother liquor may be made up of the cake filtrate and cake washes and contain residual amounts of the target compound and impurities after a batch of the target compound has been crystallized therefrom. This embodiment may comprise the steps of allowing the target compound to crystallize from an organic solvent medium, separating the crystallized target compound from this organic solvent medium mother liquor, and providing this mother liquor containing the target compound as the first solution.

In another embodiment the first solution may be a preparation medium containing the target compound resulting from preparation of the target compound therein. Such a preparation medium may contain impurities and residual starting reagents. This embodiment may comprise the steps of preparing target compound in an organic solvent medium, and providing this preparation medium as the first solution of the target compound in a first organic solvent medium.

The retentate second solution resulting from the organic solvent nanofiltration process contains solute(s), e.g. the target compound and impurities and may comprise a single organic solvent or a mixture of organic solvents. For example the second solution resulting from the process of solvent exchange using organic solvent nanofiltration may comprise a solution of the target compound in a solvent medium comprising 90 wt. % or more, e.g. 95 wt. % or more of a single organic solvent. The desired composition for the liquid mobile phase, and a corresponding liquid stationary phase, for the chromatographic process is normally selected based on desired separation performance and selected operating conditions and is commonly made of a mixture of solvents.

The retentate second solution resulting from the organic solvent nanofiltration solvent exchange may be useable directly as the liquid mobile or stationary phase in the chromatographic process.

Alternately such a second solution may be introduced with one or more additional organic solvents to make up the desired mobile or stationary phase composition.

Alternately and preferably the second solution may introduced into a liquid mobile phase as a sample which is miscible with the liquid mobile phase and thereby brought into contact with the stationary phase in the chromatographic process.

In an embodiment of the present process, in the chromatographic process the second solution resulting from the organic solvent nanofiltration solvent exchange may be injected, directly or mixed with additional solvents, into the chromatographic column and caused to flow through the column in a stream of liquid mobile phase. For example a stream of liquid mobile phase may be caused to flow through the column and the second solution may be introduced into this stream of mobile phase. Separation and elution of fractions is enabled though passage of mobile phase through the column until the target compound has passed through and exited from the column.

The chromatographic process may be a solid-liquid chromatography process with a solid stationary phase in the column as in conventional chromatography.

In a preferred embodiment, the chromatographic process is a liquid-liquid chromatographic process and both the mobile and the stationary phases are liquid phases.

The liquid-liquid chromatographic process may be any of the known types of liquid-liquid chromatography process, for example CCC or CPC, or centrifugal partition extraction, respectively using appropriate chromatography columns.

In a particularly preferred embodiment the chromatography process is a liquid-liquid CCC process, particularly in which the second solution is used as or as a component of the liquid mobile phase.

For use in liquid-liquid CCC it is necessary that the mobile phase forms a substantially immiscible phase with the stationary phase. In liquid-liquid chromatography a number of organic solvent-based systems are known from which pairs of immiscible phases suitable for use as a mobile and stationary phase can be prepared, and the second organic solvent medium is preferably selected from these and mixtures comprising them.

Suitable organic solvents for use in such pairs of immiscible phases include organic liquids which are substantially immiscible with water, for example solvents selected from C₁₋₆ alkyl C₁₋₆ alkanoate esters such as ethyl acetate; liquid C₅₋₁₀ alkanes such as heptane, organic liquids which are miscible with water such as C₁₋₈ alkanols for example as n-butanol, ethanol or methanol; and optionally water.

For example a pair of immiscible liquid phases used for a liquid-liquid chromatography process may each be made up of the components heptane, ethyl acetate, methanol and water. For example a stationary phase prepared from such a system may comprise predominantly, e.g. 50% or preferably 70% or more of a mixture of methanol and water, whilst the mobile phase may comprise predominantly, e.g. 80% or preferably 90% or more of a mixture of heptane and ethyl acetate.

A suitable example of such a stationary phase comprises 42% methanol, 38% water, 19% ethyl acetate and 0-1% heptane. A suitable example of a corresponding mobile phase for use with such a stationary phase comprises 67% heptane, 30% ethyl acetate, 2% methanol, 0-1% water. Such a combination of stationary and mobile phases is herein termed HEMWat 17.5.

Other combinations of organic solvents suitable for making combinations of stationary and mobile phases for use in liquid-liquid chromatography will be apparent to those skilled in the art.

Suitably such phases may be made by mixing the respective liquids and allowing the system to equilibrate and settle.

The second solution containing the dissolved target compound should be miscible with the liquid mobile or stationary phase, preferably with the mobile phase.

Preferably the second organic solvent medium of the second solution has a composition which corresponds to the composition of the liquid mobile or liquid stationary phase used in the liquid-liquid chromatographic process, preferably with the liquid mobile phase, so that the second organic solvent medium can be mixed with the mobile phase.

Alternatively the second solution may have a composition comprising predominantly, e.g. 75% or more, preferably 90% or more of one of the liquid components of such a liquid mobile phase, or a mixture of two or more thereof.

Therefore for use with such systems preferably the second organic solvent medium of the second solution comprises one or more of the above-listed organic solvents, e.g solvents selected from C₁₋₆ alkyl C₁₋₆ alkanoate esters such as ethyl acetate; liquid C₅₋₁₀ alkanes such as heptane, organic liquids which are miscible with water such as C₁₋₈ alkanols for example as n-butanol, ethanol or methanol; and optionally water.

For the process of solvent exchange using organic solvent nanofiltration it is also desirable that the second organic solvent is miscible with the first organic solvent medium.

The second solution produced as a result of process of solvent exchange using organic solvent nanofiltration may be mixed with other liquid solvent components such as those listed above in a liquid mobile phase for use in the chromatography process such as liquid-liquid chromatography. For example if the organic solvent medium of the second solution comprises predominantly of ethyl acetate, such a second solution may be mixed with heptane, methanol and water.

In a liquid-liquid chromatography process such as liquid-liquid CCC normally the liquid stationary phase is first introduced into the chromatography column, and the column set rotating at a selected operating speed, suitably as defined by manufacturer's specifications. Liquid mobile phase free of target compound is then introduced into the column and caused to flow through in contact with the liquid stationary phase. Mobile phase displaces stationary phase until an equilibrium is reached. The output from the column is monitored until no more stationary phase liquid is eluted by the mobile phase, indicating that equilibrium has been reached. In such a process the second solution containing dissolved solute target compound may then be introduced into the chromatography column as the mobile phase or as a component of the mobile phase, e.g. a sample dissolved therein, and caused to flow through the column.

During the chromatographic process the target compound becomes separated from impurities present together with the target compound in the second solution and can then be collected in a fraction of the output mobile phase. The target compound may then be isolated from such a fraction of the mobile phase using known techniques such as crystallisation.

In a preferred embodiment of the process the mobile phase output from the chromatographic process, whether or not solvent exchange through nanofiltration has been used prior to the chromatographic process, is purified subsequent to the chromatographic process in a solvent recovery stage by a process of organic solvent nanofiltration in which the mobile phase output from the chromatographic process is passed through an organic solvent nanofiltration membrane so that residual target compound and/or impurities in the output mobile phase are retained in the retentate and purified mobile phase passes through the membrane as a permeate.

The above-mentioned solvent recovery using organic solvent nanofiltration applied to the mobile phase output from the chromatography process may be used even with a mobile phase output from a chromatographic process in which solvent exchange using organic solvent nanofiltration has not been used prior to the chromatographic process.

Therefore a second aspect of this invention provides a process wherein the liquid mobile phase output from a chromatographic process is subjected to a process of organic solvent nanofiltration using a membrane which preferentially allows passage of organic solvent molecules therethrough, and rejects passage therefore of solute molecules.

The membrane may for example reject passage therethrough of molecules of target compound and/or impurities in the organic solvent.

Such a step of organic solvent nanofiltration can advantageously allow recycling of the mobile phase or its components in a form relatively purified of contaminating solutes, which remain largely or entirely in the retentate.

The liquid mobile phase output in this latter aspect may be the mobile phase output from a liquid-liquid chromatographic process, for example as described above and which may be based upon the organic solvents and mixtures thereof, optionally including water, as listed above. Suitable requirements e.g. of rejection for the membrane etc. in such a solvent recovery stage are as outlined above.

For example, as described above with reference to the first aspect of this invention, prior to the chromatographic process a process of organic solvent nanofiltration for solvent exchange may have been applied to provide the above-mentioned second solution for use in the chromatographic process, so that the application of a process of organic solvent nanofiltration to the liquid mobile phase output from the chromatographic process may be a subsequent such process.

In such solvent recovery processes, as the total volume for each fraction may be larger than the equipment operating volume, the solvent recovery process is preferably operated as a constant volume diafiltration with feed mobile phase being added to the system at a rate equivalent to the permeation. Such constant volume diafiltration can further reduce the number of pressure cycles the membrane is exposed to during operation.

A Starmen™ (trademark of UOP LLC, Des Plaines Ill., USA) 122 membrane may be suitable for use in such a solvent recovery process with the mobile phases discussed herein, particularly with mobile phases based on heptane, ethyl acetate, methanol and water. A mobile phase purified in this way may then be further recycled into a subsequent cycle of the chromatographic process. For example the permeate may then be re-used as a mobile phase into which a further sample of second solution may be introduced as described above. Additionally or alternatively the permeate may be used as, or as a component of a fresh batch of second organic solvent medium.

The invention will now be described by way of non-limiting example only with reference to the accompanying figures.

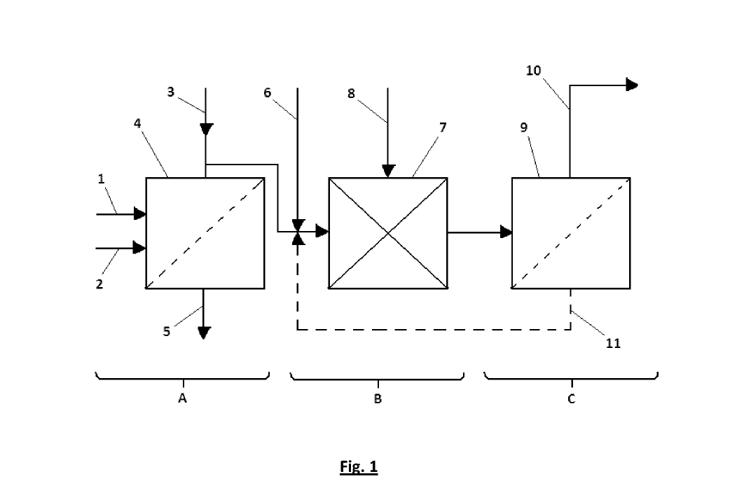

FIG. 1 shows a schematic arrangement of a possible process layout.

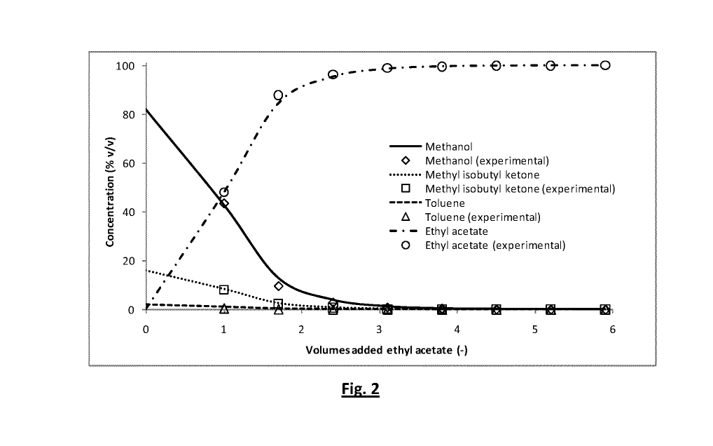

FIG. 2 shows a graph of calculated and experimental solvent levels obtained during solvent exchange using organic solvent nanofiltration.

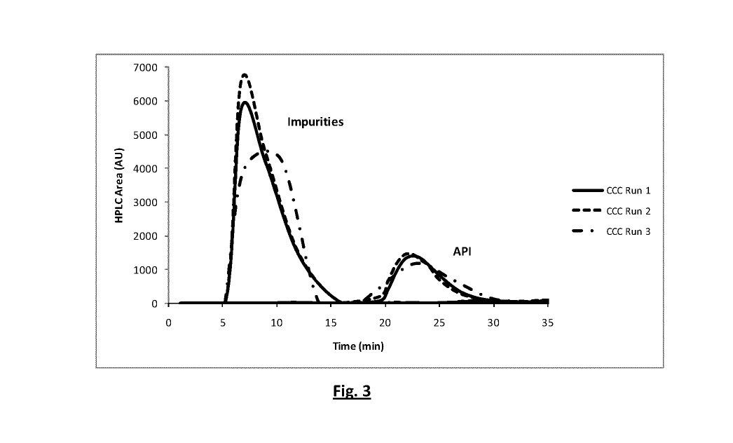

FIG. 3 shows a graphical comparison of CCC runs using fresh and recovered mobile phase.

Referring to FIG. 1 this shows a schematic equipment arrangement for performing the process of the invention.

The process illustrated in FIG. 1 comprises a sample preparation stage A and a solvent recovery stage B, and a liquid-liquid countercurrent chromatographic (“CCC”) stage C. In the process illustrated in FIG. 1 a first solution feed 1 is a crystallization mother liquor. In the experiment described below this feed 1 had a composition 82% methanol, 15.9% methyl isobutyl ketone and 2.1% toluene by volume and contained 4.5 g/L of active pharmaceutical ingredient (“API”). Feed 2 is fresh ethyl acetate. Feed 3 is a countercurrent chromatographic stage mobile phase comprising heptane and methanol. The organic solvent nanofiltration system (“OSN”) is indicated generally 4. The waste output from the OSN system is indicated 5. Feed 6 is an input of CCC mobile phase, in the experiment described below having a composition 67.32% heptane, 30.29% ethyl acetate, 2.16% methanol and 0.24% water by volume. The CCC apparatus is indicated generally 7, and the feed of CCC stationary phase, in the experiment described below having a composition 42.11% methanol, 38.24% water, 19.35% ethyl acetate and 0.31% heptane by volume is indicated 8. A further OSN system is indicated 9. Output 10 indicates the output from the OSN system 9, which may be a concentrated API solution if API-containing fractions of the output from the CCC apparatus 7 is used as the input into the OSN system 9, or a concentrated impurity solution if impurity-containing fractions of the output from the CCC apparatus 7 is used as the input into the OSN system 9. Flow line 11 indicates a flow of recovered CCC mobile phase from the OSN system 9 for recycle into the CCC apparatus 7.

### 1. ORGANIC SOLVENT NANO-FILTRATION

### 1.1 Membrane Preconditioning

All membrane discs were washed with a minimum of 40 L pure solvent per m² membrane area (i.e. 0.22 L for a 0.0054 m² disc) prior to addition of the feed solution. Washing solvent was selected based on the feed composition with pure ethyl acetate being used for the solvent exchange membranes and a mixture of 30:70% ethyl acetate and heptane being used for the solvent recovery membranes. After washing the filtration system was depressurised and the content changed for the feed solution. The feed was re-circulated through the membranes, at the desired operating pressure, for a minimum of 1.0 h or until a stable flux was reached. When operating at a stable flux the membranes were assumed to have reached close to maximum compaction and tests were started for the membrane screening, solvent exchange and solvent recovery respectively. All processing was carried out at 30 bar pressure and ambient temperature (ranging between 25-30° C.).

### 1.2 Membrane Screening

Membrane screening was carried out using a MET®Cell Cross-Flow system connecting 2-3 filtration cells with individual areas of 0.0054 m² in series. Three separate tests were carried out looking at performance in a solution mimicking the CCC mobile phase (screening solution I), pure ethyl acetate (screening solution II) and the mother liquors (screening solution III) respectively. Membrane performance was evaluated through flux and rejection calculations (see Equations 1 and 2 above) with the permeate being sampled at the end of the pre-conditioning phase and feed and retentate samples being taken at the start and finish of each test. The flux was measured every 0.5 h by collecting permeate into a measuring cylinder over a given period of time.

### 1.3 Solvent Exchange Using Organic Solvent Nanofiltration.

The starting first solution was a crystallization mother liquor comprising 82.0% methanol, 15.9% methyl isobutyl ketone and 2.1% toluene and containing 4.5 gL⁻¹ of target compound with a molecular weight of ca. 600 g mol⁻¹ and various impurities.

Solvent exchange was conducted in a MET®Cell Dead-End filtration system using a Starmem™122 membrane (batch 9101.4) and gradual addition of ethyl acetate in a put-and-take diafiltration. For each diafiltration cycle the feed (50:50% crystallisation mother liquor and ethyl acetate) was concentrated through removal of 70% of the original solvent before the system was depressurised and the remaining retentate was mixed with pure ethyl acetate to a volume of 200 mL. Concentration and addition of ethyl acetate was repeated in cycles until the desired solvent composition of the second solution was reached. To ensure maximum concentration of target compound in the CCC sample no addition of ethyl acetate was made after the final put-and-take cycle. Flux was measured every 0.5 h during the pre-conditioning and for every 50 mL permeate passed during the solvent exchange cycles. Permeate samples were taken at the start and finish of each concentration run, in addition to samples of the combined permeate. To minimise losses of the target compound the feed and retentate were sampled only at the start and finish of the full solvent exchange and estimated concentrations based on mass-balances were used for rejection calculations at all intermediate stages. To investigate membrane performance over time the same membrane disc was used for the full solvent exchange with the membrane being exposed to nine pressure cycles and over-night storage during two subsequent nights.

FIG. 2 shows how starting from the above-mentioned starting solution comprising predominantly methanol, after a series of six “put and take” cycles of organic solvent nanofiltration the final second solution, the retentate, comprises almost 100% ethyl acetate. In fact this composition of the second solution was all but achieved after three such cycles. This second solution was introduced as a sample in the CCC separation process described below.

### 1.4 CCC Separation

Analytical scale CCC runs were carried out using a Mini centrifuge supplied by Dynamic Extractions Ltd. The Mini equipment contains a centrifuge fitted with a single bobbin 20 mL coil made up of 0.8 mm bore tubing. During CCC operation the coil acts as the column and for the Mini operation the spin rate was set to a constant value of 2100 rpm. After equilibration of the column a sample volume of 0.9 mL of second solution with dissolved target compound was injected and CCC operation was carried out using a flow rate of 1.5 mL min⁻¹ for a total of 35 min collecting 10 fractions of 5.25 mL each. A larger scale CCC run was conducted using a Midi Centrifuge system also supplied by Dynamic Extractions Ltd. The set-up for the Midi equipment was similar to the Mini, with the exception that the centrifuge volume was divided between two bobbin coils of 4.0 mm bore tubing having a combined volume of 925 mL. For Midi scale operation a lower spin rate of 1400 rpm was used to maintain a comparable gravitational field to the Mini run. Additional parameters were scaled through linear volumetric scale-up with a sample size of 41 mL injected using a total processing time of 35 min at a flow rate of 70 mL min⁻¹ for the mobile phase, collecting 10 fractions of 245 mL each. Fraction collection for both the Mini and the Midi runs were started immediately after the sample was injected. Prior to sample injection on both Mini and Midi scales the column was pre-conditioned by pumping mobile phase through the column gradually displacing stationary phase. Pre-conditioning was continued until the equilibrium when no more stationary phase was eluting, at which point maximum stationary phase retention was assumed. For all CCC runs the outward flow was connected to a diode array detector set at 260 nm to enable in-process monitoring of impurity and elution of the target compound.

To minimise solvent requirements and to maintain a mimic analogous of industrial preparation, stationary and mobile phases were made up individually as single saturated phases. Based on previous method development the most suitable solvent system was selected as heptane/ethyl acetate/methanol/water corresponding to a stationary phase composition of 42.11% methanol, 38.24% water, 19.35% ethyl acetate and 0.31% heptane, and a mobile phase composition of 67.32% heptane, 30.29% ethyl acetate, 2.16% methanol and 0.24% water, equivalent to HEMWat 17.5. To ensure consistency of stationary and mobile phases, a partitioning test was carried out comparing data from the individually made up phases to these compositions made up as a bulk phase system. As a partitioning test 1 mg of crude material (fully evaporated mother liquor sample) was dissolved in 0.5 mL of stationary and mobile phase respectively from fresh solvent system used for CCC run 1, recovered solvent system used for CCC run 2 and HEMWat 17.5 made up as a bulk phase system. Samples were mixed and allowed to settle prior to HPLC analysis of each phase.

### 1.5 Solvent Recovery

Solvent recovery was carried out in a MET®Cell Dead-End filtration system using Starmem™240 (batch 9217.1) for all processing. To minimise the number of pressure cycles, and as the total volume for each fraction was larger than the equipment operating volume, solvent recovery was operated in a constant volume diafiltration with feed solution being added to the system at a rate equivalent to the permeation. Diafiltration was continued until the full volume had been added to the system after which the feed was concentrated to a level limited by the solubility limit for each fraction. The flux was measured every 0.5 h during the pre-conditioning and for every 50 mL permeate passed during the recovery. Permeate samples were taken at the start and finish of each recovery run, in addition to samples of the combined permeate, and the feed and retentate were sampled at the start and finish of recovery from each fraction. To ensure consistent membrane performance a new membrane disc was used for solvent recovery from each fraction.

### 1.6 Analysis

Target compound and impurity concentrations were monitored using an Agilent 1100 Series HPLC system. No details on analytical technique can be disclosed to ensure confidentiality of target compound structure and properties.

Solvent levels for ethyl acetate, heptane, methanol, methyl isobutyl ketone and toluene (the latter being present in the first solution) were analysed using a Hewlett Packard HP 6890 Series Gas Chromatograph (GC) system. Samples were analysed using a flame ionization detector with a 10 m long, 200 μm diameter and 1.12 μm film thickness DB-624 GC column (Agilent Technologies, Delaware). The oven temperature was held initially at 240° C. and the column temperature was controlled with a program ranging from an initial value of 35° C. held for 2.0 min, increased to 80° C. at 50° C. min⁻¹ and held for 1.0 min and finally increased to 150° C. at 210° C. min⁻¹ and held for 1.0 min. The injector temperature was kept constant at 200° C. and the total injection volume was set to 1.0 μL using a split injector mode of 40:1. The detector temperature was set to 250° C. and detection was enabled using a make-up flow of 34.0 mL min⁻¹ nitrogen combined with an air flow of 450.0 mL min⁻¹ and a hydrogen flow of 40.0 mL min⁻¹. Helium was used as a carrier gas and the flow rate was determined through a pressure ramp ranging from 2.85 to 30.6 psi over 6.3 min. Traces of water in the solvent mixture were measured using volumetric Mitsubishi Karl Fischer moisturemeter CA-100/KF-100.

### 2. RESULTS AND DISCUSSION

### 2.1 Membrane Screening

The most important part for successful operation of organic solvent nanofiltration is selection of a suitable membrane and the first stage for an organic solvent nanofiltration application is commonly a membrane screening. Ideally the selected membrane should have excellent long-term stability in all processing solvents used, and display sharp MWCO curves ranging up to 100% rejection to minimise solvent requirements and solute losses during filtration. Additionally a high solvent permeation rate is desirable and flux must be high enough to enabling processing within a reasonable time and membrane area.

For the organic solvent nanofiltration application discussed here, solvent recovery and a majority of the solvent exchange should ideally be carried out in a solvent composition similar to the CCC mobile phase (67.32% heptane, 30.29% ethyl acetate, 2.16% methanol and 0.24% water). To evaluate membrane performance the mobile phase composition was hence selected as screening solution I and a solution containing 4.5 g L⁻¹ target compound was used for the study. In addition to the target compound crystallization mother liquors contained various concentrations of 27 different impurities. To obtain maximum information prior to membrane selection, all impurities should ideally be included in the screening solution. However impurities are not readily available in dry form and consequently the target compound was selected as the sole, initial marker for evaluating membrane performance (see Table 1). Membranes selected for screening experiments included membranes from the Duramem™, Starmem™ and Puramem™ series, a range of commercially available membranes suitable for use in organic solvents.

TABLE 1
Summary of target compound rejection and flux data for screening
solution 1 (CCC mobile phase)

| Membrane | MWCO (g mol⁻¹) | Flux (L m⁻² h⁻¹) | Rejection (%) |
|---|---|---|---|
| Duramem ™150 | 150^{a} | 0.2 | 76.1 |
| Duramem ™200 | 200^{a} | 28 | 21.7 |
| Starmem ™122 | 220^{b} | 8 | 83.1 |
| Starmem ™240 | 400^{b} | 48 | 98.5 |
| Puramem ™280 | 280^{c} | 9 | 86.7 |

^{a}Based on rejection of styrene oligomers dissolved in acetone
^{b}Based on rejection of alkanes dissolved in toluene
^{c}Based on rejection of styrene oligomers dissolved in toluene

Screening in the CCC mobile phase indicated that the observed rejection for all membranes tested was below the desired value of >99%, with the most promising result being observed for Starmem™240 having a measured rejection of 98.5% and a flux of 48 L m⁻² h⁻¹ (see Table 1). The low rejections observed for Duramem™150, Duramem™200 and Starmem™122 (76.1, 21.7 and 83.1% respectively) were unexpected as all three membranes have MWCOs significantly below the molecular weight of the target compound. Deviation from the expected rejection values are likely to be the result of different solvents being used in the membrane screening compared to the MWCO characterisation. Changing results for different solvent-solute combinations indicated that a more universal characterisation method for membrane performance was highly desirable. However until such data is available membrane screening remains an important part for any membrane process under development. Additionally of interest is that the flux for Duramem™200 was increasing from 11 to a semi-stable value of 27-29 L m⁻¹ h⁻¹ throughout the screening. The flux increase in combination with the low rejection values observed could indicate that this membrane was less suitable for use in heptane containing solvent mixtures.

Starmem™240 displayed a high rejection for the target compound and hence could potentially be used for recovery of CCC mobile phase through a single or multiple membrane pass (see Section 1.5 above). However for a solvent exchange multiple permeate passes are not suitable from a processing perspective and the measured rejection of 98.5% for Starmem™240 was calculated to result in target compound losses of approximately 8% throughout the solvent exchange. Potential losses of target compound indicate that a solvent exchange directly into mobile phase was feasible but not ideal, and another alternative was highly desirable. The second largest component in the CCC mobile phase was ethyl acetate, and in an attempt to improve rejection and hence minimise the overall target compound losses, solvent exchange was carried out from the first solvent crystallization mother liquor directly into pure ethyl acetate rather than the full CCC mobile phase composition. Once the components had been exchanged into ethyl acetate the solution could be made up to the correct CCC sample composition. For an exchange directly into ethyl acetate the CCC sample would be more dilute, however the process offers significant advantages as several membranes stable for use in ethyl acetate are commercially available. Pure ethyl acetate was selected as screening solution II with the target compound used as a marker for membrane performance (see Table 2). Finally to evaluate potential changes in membrane performance for different solvents, and to get an estimation of the rejection of the impurities present, the crystallisation mother liquor was selected as screening solution III (see Table 2).

TABLE 2
Result summary for screening solution II (ethyl acetate) and III
(crystallisation mother liquor)

| | | | Rejection |
|---|---|---|---|
| Membrane | Screening solution | Flux (L m⁻² h⁻¹) | (%) |
| Duramem ™150 | II | 5 | 99.1 |
| Duramem ™200 | II | 29 | 91.6 |
| Starmem ™122 | II | 84 | 99.8 |
| Starmem ™240 | II | 88 | 99.5 |
| Puramem ™280 | II | 77 | 99.6 |
| Duramem ™150 | III | 16 | 99.2 |
| Duramem ™200 | III | 55 | 96.5 |
| Starmem ™122 | III | 59 | 98.4 |
| Starmem ™240 | III | 48 | 98.9 |
| Puramem ™280 | III | 53 | 98.2 |

For screening in ethyl acetate (solution II) the strongest membrane performance was observed for Starmem™122 having an target compound rejection of 99.8% combined with a high flux of 84 L m⁻² h⁻¹. When using the crystallisation mother liquor (solution III, 82.0% methanol, 15.9% methyl isobutyl ketone, 2.1% toluene containing ˜4.5 g L⁻¹ target compound and 27 different organic impurities) the target compound rejection for Starmem™122 was however reduced to 98.4%, and the most suitable membrane performance was observed for Duramem™150 having a rejection of 99.2% in combination with a flux of 16 Lm⁻²h⁻¹. A similar decrease in rejection was also observed for Starmem™240 and Puramem™280 when comparing data from screening tests in ethyl acetate and the crystallisation mother liquors, whereas for Duramem™150 and Duramem™200 the rejection remained constant or increased during screening in the mother liquors compared to data in ethyl acetate. Changes in rejection are likely to be a result of the changing solvents influencing the membrane performance however additional factors such as solvent-solute interactions could also be contributing to the observed changes. The majority of the solvent exchange discussed here used solutions composed mainly of ethyl acetate and only the initial concentration stage was carried out using a feed that was closer to the crystallisation mother liquor composition (see Section 2.2). Based on this information Starmem™122 was selected as the most suitable membrane candidate for the solvent exchange.

### 2.2 Solvent Exchange

For the solvent exchange described, calculations indicated that compared to discontinuous operation, continuous operation required an additional 3.5 diafiltration volumes (1 diafiltration volume=200 mL or the feed volume) of solvent to reach the desired second solution solvent composition. In order to conserve mass-efficiency, a put-and-take diafiltration using a 400 mL 50:50 mixture of crystallisation mother liquor and ethyl acetate as feed and a concentration level of 70% for each cycle, was selected for the solvent exchange.

The solvent target composition for the second solution was set to 99.99% (% volume) ethyl acetate with trace levels of solvents from the mother liquor (methanol, methyl isobutyl ketone and toluene) restricted to a maximum level of 0.01% (% volume). The level for mother liquor solvent traces was set to a very low value to limit potential contamination of the CCC stationary phase. The solvent level for each cycle was calculated using a mass-balance assuming 0% rejection for all solvents present (see FIG. 2). Mass-balance was calculated based on Equation 3 where C is the concentration of solvent component i in the feed (f), permeate (p), added diafiltration volume (d) and retentate (r) respectively, and V is the volume. Important to note is that the retentate volume refers to the volume after the put-and-take cycle has been completed, and is hence equal to the feed volume.

$${C}_{i , f} = \frac{{V}_{f} {C}_{i , f} - {V}_{p} {C}_{i , p} + {V}_{d} {C}_{i , d}}{{V}_{r}} \qquad Equation 3$$

Solvent levels were monitored for each put-and-take cycle of the solvent exchange using GC. Data indicate that the desired solvent composition was reached after eight additions of ethyl acetate making up a total of 5.9 diafiltration volumes, for a starting volume of 400 mL containing 200 mL mother liquor (see FIG. 2 and Table 3). The measured solvent composition correlated well with the calculated level from the mass-balance indicating that the assumption of a 0% solvent rejection holds true for the given system, and for a well mixed solution the solvent composition should be maintained over the membrane (see FIG. 2).

Analysis of target compound concentrations in the feed, permeate and retentate showed that the target compound rejection ranged between 99.3-99.9% for all put-and-take cycles, resulting in an overall target compound loss of 2.3% (see Table 3). Observed rejections were consistent with data measured during membrane screening for all stages except the initial concentration of the mother liquor (see Section 2.1). Prior to the first put-and-take cycle, ethyl acetate was added to the crystallisation mother liquors to a level of 50% (% volume). For the mixed feed the target compound rejection was observed to increase from the expected value of 98.4% to a value of 99.3% (see Table 3) and though some losses of target compound will still occur, this study showed that the overall losses can be minimised through early addition of ethyl acetate. The observed increase in target compound rejection for addition of ethyl acetate was consistent with trends observed during the membrane screening (see Table 2), and strongly indicated that the performance of Starmem™122 was dependent on membrane-solvent-solute interactions.

TABLE 3
Summary of the observed rejection, target compound losses and
solvent composition for each put-and-take solvent addition.

| | | | | Solvent composition % volume | | | |
|---|---|---|---|---|---|---|---|
| | Added | Rejec- | API | Meth- | | Tol- | Ethyl |
| | volume^{a} | tion | losses | anol | MiBK^{b} | uene | acetate |
| Cycle | (—) | (%) | (%) | (% v/v) | (% v/v) | (% v/v) | (% v/v) |
| 1¹ | 1.0 | 99.3 | 1.4 | 43.58 | 8.09 | 0.36 | 47.97 |
| 2 | 1.7 | 99.7 | 1.6 | 9.72 | 2.38 | 0.08 | 87.83 |
| 3 | 2.4 | 99.9 | 1.7 | 2.98 | 0.76 | 0.01 | 96.25 |
| 4 | 3.1 | 99.9 | 1.7 | 0.94 | 0.22 | 0.010 | 98.84 |
| 5 | 3.8 | 99.9 | 1.8 | 0.44 | 0.06 | 0.001 | 99.50 |
| 6 | 4.5 | 99.9 | 1.8 | 0.13 | 0.003 | <0.001 | 99.87 |
| 7 | 5.2 | 99.9 | 1.8 | 0.07 | <0.001 | <0.001 | 99.93 |
| 8 | 5.9 | 99.4 | 2.2 | 0.01 | <0.001 | <0.001 | 99.99 |
| Reten- | 5.9 | — | 2.3 | 0.01 | <0.001 | <0.001 | 99.99² |
| tate | | | | | | | |

¹First Solution initial composition.
²Second Solution composition
^{a}1 volume = 200 mL (feed volume)
^{b}Methyl isobutyl ketone

### 2.3 Counter Current Chromatography (CCC)

Prior to the CCC separations K_{d} values of the individually prepared stationary and mobile phases were evaluated. Partitioning samples were analysed with HPLC and data indicated that for both fresh and recovered solvent for the individually prepared phases for the Mini runs and for a bulk prepared HEMWat 17.5 system, K_{d} values were equal to 1.06. Consistent K_{d} values indicated that there was no significant difference in the partitioning between solvent systems made up as single phases compared to HEMWat 17.5 made up as a bulk phase. Additionally calculated K_{d} ratios for the target compound and related impurities indicate that the separation factor was above 1.5 for all impurities except two where the values were 1.1 and 1.3 respectively. Separation factors were consistent between single phases and HEMWat 17.5 and correspond to previous data indicating that HEMWat 17.5 was the most suitable solvent system for separation of the target compound and impurity with only minor co-elution occurring.

For CCC operation the resulting solution from the solvent exchange (see Section 2.2) was mixed with fresh methanol, heptane and water to make up samples with the desired mobile phase composition of 67.32% heptane, 30.29% ethyl acetate, 2.16% methanol and 0.24% water. CCC was then used to separate the target compound from impurities present in the incoming feed stream. Two CCC Mini runs were carried out on a 0.9 mL sample scale using fresh (CCC run 1) and recovered solvent (CCC run 2, see Section 2.4) respectively as mobile phase. For both Mini runs the stationary phase retention was measured to 83% and each separation was run for a total of 35 min with fraction collection starting immediately after sample injection and continuing for a total of 10×3.5 min intervals. Individual CCC fractions from Run 1 and 2 were analysed with HPLC and data indicated that the separation profile for CCC Run 1 and 2 operating on fresh and recovered mobile phase respectively, were almost identical (see FIG. 3). For both CCC Run 1 and 2 the majority of the impurities were eluted between 5 and 15 min with only trace amount visible at higher elution times (see FIG. 3). The target compound eluted between 20 and 30 min after the initial impurity block and HPLC data indicated that 77.5-80.0% of the added target compound eluted in fractions with purities ranging from 91.6-100%. All additional target compound containing fractions ranged in purity between 27.0-85.2% with the overall target compound recovery adding up to approximately 100% for both runs (see Table 4). Though a 90% purity was not considered sufficient for the final product, the target compound was recovered from the fractions though crystallisation generally resulting in a purity >99%.

It is important to note that consistent performance was observed for CCC Run 1 and 2 with no indication of impurity enrichment in the target compound containing fractions when recovered solvent was used as mobile phase for separation. The relatively high purity for the target compound fractions further indicated sufficient separation performance for the CCC and feasibility for initial target compound purification could be considered proven.

In addition to small scale CCC runs for demonstration of feasibility, one run was carried out on a larger (Midi) scale to generate sufficient mobile phase for recovery and recycle into subsequent CCC operation (for use in CCC Run 2). For the larger scale run the stationary phase retention was measured to 80% and the CCC separation was operated using a 41 mL sample and fresh solvent to make up the mobile phase and a total of 2450 mL solvent was eluted in 10 separated fractions. HPLC data indicated that the target compound was eluting in the final 5 fractions with impurities ranging between 62.2-100.0% (see FIG. 3). Of interest is that the fractions with lower purities had low target compound concentrations and in absolute values the impurities present were minimal and likely to wash away during target compound recovery through crystallisation. The elution profile for the Midi run differed slightly from that observed during the Mini operations (see FIG. 3). Though the impurities and target compound were still eluting within approximately the same time interval as for the Mini runs, the target compound peak was broader resulting in target compound eluting over a larger range of fractions. Minor differences in elution profiles could potentially be a result of small differences in phase compositions indicated by the lower stationary phase retention for the Midi run, in combination with minor differences in mixing in the various size equipment.

It was important to note however that target compound elution time as well as purities of target compound fractions from this larger scale Midi CCC run were similar to data observed for the smaller scale runs, and CCC performance was observed to be consistent at the two scales tested. FIG. 3 shows a comparison of HPLC reconstructed chromatograms for CCC Run 1 (Mini, fresh solvent for mobile phase), Run 2 (Mini, recovered solvent for mobile phase) and Run 3 (Midi, fresh solvent for mobile phase—material for solvent recovery).

TABLE 4
Target compound recovery from CCC runs 1 and 2

| | CCC run 1 | CCC run 2 |
|---|---|---|
| Recovered targ. cpd. (mg) | 3.51 | 3.59 |
| Total targ. cpd. added (mg) | 3.51 | 3.51 |
| Overall recovery (%) | 99.9 | 102.3 |

### 2.4 Solvent Recovery

Feasibility of solvent recovery was investigated for the mobile phase collected from larger scale CCC run (see Section 3.3). The eluted mobile phase was divided into 4 fractions depending on content (see Table 5), and feasibility of solvent recovery was investigated separately for each fraction. Fractions were studied separately to enable recovery of target compound and to minimise the risk of including low molecular weight impurities, which are not easily removable by organic solvent nanofiltration, into the recovered solvent.

TABLE 5
Summary of CCC run 3 mobile phase fractions investigated for solvent
recovery potential.

| Fraction | Organic content | Volume (mL) | Rejection (%) | OSN recovery |
|---|---|---|---|---|
| F0 | Low concentration, 2 impurities | 505 | 13-47 | Yes |
| F1-F2 | High concentration, 20 impurities | 490 | 0-100 | No |
| F3-F5 | Low concentration, 7 impurities | 735 | 17-100 | Yes |
| F6-F10 | Intermediate concentration, API only | 1225 | 98.5 | Yes |
| Total | — | 2955 | — | — |

For recycle of solvent into subsequent CCC operations the selected solvent specification required that the recovered solvent must be within 0.5% (% volume) of the desired solvent composition and contain a total of no more than 1% (area % by HPLC) impurities. HPLC data indicate that for fractions F0 and F3-F5 the overall impurity content and concentration was low (see FIG. 3 and Table 5), and despite rejection values ranging between 13 and 100%, impurity removal was expected to be sufficient to attempt solvent recovery in a single membrane pass. Fraction F6-F10 contained the target compound and concentrated material was intended for target compound recovery through crystallisation. The rejection of target compound was high at 98.5%, indicating that solvent could be recovered in a single membrane pass. However to ensure minimal losses of target compound a dual membrane stage was used for solvent recovery with the retentate from each stage collected separately. Finally HPLC data for fractions F1-F2 indicated that the overall impurity content and concentration was high, with impurity rejections ranging between 0 and 100%. The low rejections measured in combination with high starting concentrations indicated that even if multiple membrane passes were to be used, the recovered permeate would still be far from the solvent specification. Fractions F1-F2 were hence considered unsuitable for solvent recovery and were discarded as waste. The solvent composition for each recovered fraction was analysed with GC and Karl Fisher prior to combining the solvent into the final recovered mobile phase (see Table 6). The composition of the combined solvent was measured to be 67.7% heptane, 30.2% ethyl acetate, 1.9% methanol and 0.3% water hence deviating from the desired HEMWat 17.5 composition by a maximum of 0.4% (% volume) for heptane. Partition testing revealed that the K_{d} of target compound in the recovered mobile phase was 1.06 which was consistent with values observed for HEMWat 17.5 and fresh solvent phases used for CCC run 1 (see Section 2.3). Consistent target compound K_{d} values indicated that minor differences in the solvent composition had no significant impact on the solute partitioning.

HPLC analysis of the recovered solvent further indicated that the impurity trace in the combined permeate was 0.46% (area % by HPLC) which was significantly lower than the set target of 1% (area % by HPLC). The recovered solvent was hence within the solvent specification and was considered suitable for re-cycling into subsequent CCC operation. Feasibility for solvent recovery was further confirmed by consistent CCC performance, with no indication of impurity build-ups in the target compound containing fractions, when operating using recovered solvent (CCC run 2, see Section 2.3).

TABLE 6
Solvent composition based on GC and Karl Fisher data

| | | Ethyl | | | Impu- | |
|---|---|---|---|---|---|---|
| | Heptane | acetate | Methanol | Water | rities | Volume |
| Fraction | (% v/v^{a}) | (% v/v^{a}) | (% v/v^{a}) | (% v/v^{a}) | (% a/a^{b}) | (mL) |
| F0 | 66.64 | 30.55 | 2.20 | 0.32 | 0.46 | 435 |
| F3-F5 | 67.76 | 29.81 | 2.11 | 0.33 | 0.47 | 660 |
| F6-F10 | 67.64 | 30.35 | 1.72 | 0.29 | 0.45 | 890 |
| Combined | 67.65 | 30.18 | 1.88 | 0.29 | 0.46 | 1985 |
| permeate | | | | | | |
| Desired | 67.32 | 30.29 | 2.16 | 0.24 | | |
| composition | | | | | | |

^{a}% volume
^{b}% area by HPLC

### 2.5 Solvent Mass-Intensity

The mass-intensity for a process is defined as the ratio between the total mass of material used to generate a quantity of product per unit target compound produced and is used as a measurement for process comparison in the pharmaceutical industry. Mass intensity values were calculated and used as a basis for comparison for CCC operation with and without solvent recovery and organic solvent nanofiltration solvent exchange respectively (see Table 7). As expected mass-intensity data indicated that the solvent intensity for CCC operation alone was high at a value of 29×10³, however when CCC operation was combined with solvent recovery the solvent mass-intensity was calculated to decrease by 60% for a solvent recovery level of 70% (obtained recovery level from CCC Run 3). Solvent mass-intensity data further indicated that when the solvent requirement for the organic solvent nanofiltration solvent exchange was included for comparison, the overall solvent intensity increased. This is consistent with expected behaviour as additional solvent was used. However the organic solvent nanofiltration solvent exchange only resulted in a relative mass-intensity increase of 5% for the CCC process with no solvent recovery and 10% for the CCC process with solvent recovery. When comparing the overall CCC process this further means that even when the relatively solvent intensive organic solvent nanofiltration solvent exchange is used, the overall solvent mass-intensity for CCC operation with and without solvent recovery could be reduced by 56%.

TABLE 7
Calculated mass-intensity for CCC run 1 and 2.

| | Solvent | | |
|---|---|---|---|
| Process | exchange | Solvent recovery^{a} | Solvent mass-intensity |
| CCC Run 1 | Not included | 0% | 29 × 10³ |
| CCC Run 1 | Included | 0% | 30 × 10³ |
| CCC Run 2 | Not included | 70%^{b} | 12 × 10³ |
| CCC Run 2 | Included | 70%^{b} | 13 × 10³ |

^{a}Solvent recovery is limited to the mobile phase
^{b}Equivalent to recovery level obtained in CCC Run 3

### 4. CONCLUSION

The experimental work presented here demonstrated that separations using CCC can be far more efficient when coupled with organic solvent nanofiltration technology. Organic solvent nanofiltration solvent exchange generated sample solutions for CCC within specification and feasibility was demonstrated through successful CCC operation. Although solvent exchange using organic solvent nanofiltration diafiltration is a relatively solvent intensity process (see Table 7) alternative thermal routes can be problematic, particularly if azeotropic mixtures are present, or the swap is from a high boiling point solvent to a low boiling point solvent. Additionally organic solvent nanofiltration can avoid potential thermal degradation of target compound and may provide benefits with regards to improved energy-efficiency. Throughout the solvent exchange the target compound rejection remained >99% but despite high target compound rejection the overall target compound loss added up to 2.3%. Losses of target compound highlight that membranes with 100% rejection are desirable and membrane development remains an important area of research. Improvements of the overall process mass-intensity was demonstrated through organic solvent nanofiltration solvent recovery and recycle of CCC mobile phase.

Feasibility for solvent recovery was demonstrated through recovery of solvent within the stated solvent specification and with consistent partitioning values to the mobile phase prepared using fresh solvents. Recovered solvent was used for successful CCC separation demonstrating consistent performance to operation carried out using fresh solvent. Comparison of mass-intensity data show that even when the solvent intensive organic solvent nanofiltration solvent exchange was used for sample preparation, recycle of the mobile phase resulted in a 56% improvement of the mass-intensity of this CCC process indicating a significant potential for improving overall CCC mass-efficiency.

1. A process for separating a target compound from a solution of the target compound in an organic solvent medium by means of a chromatographic process using the solution as, or in mixture with, a liquid mobile or stationary phase together with a respective corresponding stationary phase or liquid mobile phase such that the target compound partitions between the liquid mobile phase and the stationary phase enabling the dissolved target compound to become concentrated in a fraction of the mobile phase, wherein:
prior to the chromatographic process the composition of a first solution of the target compound in a first organic solvent medium is changed by means of a process of organic solvent nanofiltration for a solvent exchange to provide said solution of the target compound as a second solution of the target compound in a second organic solvent medium having a different organic solvent composition from said first solution, and/or;
subsequent to said chromatographic process the mobile phase output from the chromatographic process is subjected to a process of organic solvent nanofiltration in which the output mobile phase from the chromatographic process is passed through an organic solvent nanofiltration membrane so that residual target compound and/or impurities in the output mobile phase are retained in the retentate and purified mobile phase passes through the membrane.

2. A process according to claim 1 for separating a target compound from a first solution of the target compound in a first organic solvent medium comprising the steps of:
changing the composition of the first solution using organic solvent nanofiltration for a solvent exchange to provide a second solution of the target compound in a second organic solvent medium,
then in a chromatographic process using the second solution as, or in mixture with, a liquid mobile or stationary phase together with a respective corresponding stationary phase or liquid mobile phase such that the target compound partitions between the liquid mobile phase and the stationary phase enabling the dissolved target compound to become concentrated in a fraction of the mobile phase.

3. A process according to claim 1 wherein the target compound is thereafter isolated from the fraction of the liquid mobile phase containing the target compound in solution.

4. A process according to claim 1 wherein the solvent exchange through nanofiltration is carried out through a discontinuous process in which feed of first solution is concentrated by passage through the membrane before the passage is stopped, and the feed volume is then adjusted by mixing with solvent component(s) of the second organic solvent medium.

5. A process according to claim 4 wherein each membrane passage of the solvent medium containing the target compound removes more than 50% of the solvent medium.

6. A process according to claim 4 wherein five to eight passages are done.

7. A process according to claim 2 wherein the solvent exchange through nanofiltration is carried out through a continuous process in which fresh solvent component(s) of the second organic solvent medium are added to the feed first solution at a rate equivalent to the permeation such that the composition gradually changes from that of the first solution to that of the second solution.

8. A process according to claim 1 wherein the membrane rejection Ri for the target compound is 90% or more.

9. A process according to claim 2 wherein solvent component(s) of the second organic solvent medium is/are added to the first solution of the target compound prior to subjecting the first solution to the process of solvent exchange.

10. A process according to claim 9 in which 40% or more by volume of a second organic solvent is added to the first solution prior to passing it through the membrane.

11. A process according to claim 1 wherein the first solution of the target compound is a mother liquor collected from a crystallization of the target compound.

12. A process according to claim 1 wherein the first solution is a preparation medium containing target compound resulting from preparation of the target compound therein.

13. A process according to claim 1 wherein the chromatographic process is a liquid-liquid chromatographic process and the stationary phase is a liquid phase.

14. A process according to claim 13 wherein the liquid-liquid chromatographic process is a counter current chromatography process.

15. A process according to claim 13 wherein the second solution is used as or as a component of the liquid mobile phase.

16. A process according to claim 13 wherein the second solution is introduced into the liquid mobile phase as a sample to become a component of the liquid mobile phase and thereby brought into contact with the stationary phase in the chromatographic process.

17. A process according to claim 16 wherein the chromatographic process the second solution is injected into the chromatographic column and caused to flow through the column in a stream of liquid mobile phase.

18. A process according to claim 16 wherein a stream of liquid mobile phase is caused to flow through the column and the second solution is introduced into this stream of mobile phase.

19. A process according to claim 15 wherein the second organic solvent medium of the second solution comprises one or more liquid component which is suitable for a liquid mobile phase immiscible with the liquid stationary phase.

20. A process according to claim 13 wherein the mobile and stationary liquid phase comprise solvents selected from C₁₋₆ alkyl C₁₋₆ alkanoate esters; liquid C₅₋₁₀ alkanes; and C₁₋₈ alkanols.

21. A process according to claim 20 wherein the mobile and stationary phases are a pair of immiscible liquid phases each comprising the components heptane, ethyl acetate, methanol and water.

22. A process according to claim 21 wherein the stationary phase comprises 50% or more of mixed methanol and water, and the mobile phase comprises 80% or more of mixed heptane and ethyl acetate.

23. A process according to claim 13 wherein the second organic solvent medium of the second solution comprises components heptane, ethyl acetate, methanol and water.

24. A process according to claim 13 wherein the second organic solvent medium of the second solution has a composition which corresponds to the composition of the liquid mobile or liquid stationary phase used in the liquid-liquid chromatographic process.

25. A process according to claim 2 wherein the mobile phase output from the chromatography column is purified in a solvent recovery stage by a further process of organic solvent nanofiltration in which the output mobile phase from the chromatography process is passed through an organic solvent nanofiltration membrane so that residual target compound and/or impurities in the output mobile phase are retained in the retentate and purified mobile phase passes through the membrane.

26. A process wherein the liquid mobile phase output from a chromatographic process is subjected to a process of organic solvent nanofiltration using a membrane which preferentially allows passage of organic solvent molecules therethrough, and rejects passage therefore of solute molecules.

27. A process according to claim 26 wherein the liquid mobile phase output is the mobile phase output from a liquid-liquid chromatographic process.

28. A process according to claim 26 wherein the solvent recovery process is operated as a constant volume diafiltration with feed mobile phase being added to the system at a rate equivalent to the permeation.
